(19) United States
(12) Patent Application Publication
(10) Pub. No.: US 2014/0286415 A1
(43) Pub. Date: Sep. 25, 2014

(54) VIDEO ENCODING/DECODING METHOD AND APPARATUS FOR SAME

(71) Applicant: ELECTRONICS AND TELECOMMUNICATIONS RESEARCH INSTITUTE, Daejeon (KR)

(72) Inventors: Jung Won Kang, Daejeon (KR); Hui Yong Kim, Daejeon (KR); Ha Hyun Lee, Seoul (KR); Gun Bang, Daejeon (KR); Jin Soo Choi, Daejeon (KR); Won Sik Cheong, Daejeon (KR); Nam Ho Hur, Daejeon (KR); Jin Woong Kim, Daejeon (KR)

(21) Appl. No.: 14/350,225

(22) PCT Filed: Oct. 5, 2012
(86) PCT No.: PCT/KR2012/008097

§ 371 Date: Apr. 7, 2014

(30) Foreign Application Priority Data
Oct. 5, 2011 (KR) 10-2011-0101059
Oct. 5, 2012 (KR) 10-2012-0110803

(51) Int. Cl. H04N 19/597; H04N 19/33; H04N 19/31

(52) U.S. Cl. CPC H04N 19/00769; H04N 19/0043; H04N 19/00436
USPC 375/240.12

(57) ABSTRACT

According to the present invention, a video decoding method comprises: a step of decoding a first bitstream corresponding to a base layer image based on first decoding information corresponding to the image that belongs to the view which is different from the view to which the base layer image belongs; and a step of decoding a second bitstream corresponding to an enhancement layer image based on second decoding information corresponding to the base layer image and third decoding information corresponding to the image that belongs to the view which is different from the view to which the enhancement layer image belongs.

### CROSS-REFERENCE TO RELATED APPLICATIONS

This application claims the benefit of priority of Korean Patent Application No. 10-2011-0101059 filed on Oct. 5, 2011, and Korean Patent Application No. 10-2012-0110803 filed on Oct. 5, 2012, all of which is incorporated by reference in its entirety herein.

### BACKGROUND OF THE INVENTION

1. Field of the Invention

The present invention relates to an image processing, and more particularly, to a method and apparatus for encoding/decoding video.

2. Related Art

Nowadays, while a broadcasting service having a high definition (HD) resolution is enlarged to world as well as domestic, many users are familiar in an image of a high resolution and a high quality and thus many institutions make an effort for development of a next generation image device. Further, while an interest about ultra high definition (UHD) having a resolution of quadruple or more of HDTV together with HDTV increases, compression technology of an image of a higher resolution and a high quality is requested. Therefore, ICIC taking consideration of the difference in downlink timing of multiple cells is needed.

For image compression, inter prediction technology that predicts a pixel value included from a prior picture and/or a posterior picture to a present picture, intra prediction technology that predicts a pixel value included in a present picture using pixel information within the present picture, and entropy encoding technology that allocates a short code to a symbol having a high appearance frequency and that allocates a long code to a symbol having a low appearance frequency may be used.

Image compression technology includes technology that provides a constant network bandwidth under a limited operation environment of hardware without considering a floating network environment. However, in order to compress image data applied to a network environment in which a bandwidth frequently changes, new compression technology is requested, and for this purpose, a method of encoding/decoding a scalable image may be used.

A digital broadcasting service using a three-dimensional (3D) image has been in the spotlight as a next generation broadcasting service following HDTV together with an UDTV service, and it is expected that a 3DTV service in which each family can enjoy a 3D image based on development of related technology such as launching of a high quality commercial 3D display will be provided within several years. In order to provide a 3D image, a method of encoding/decoding a multiview image is used. In a 3D video service, two or more views of images are displayed in a spatially divided display panel, images of each individual view may be simultaneously reproduced. Therefore, images of different views may be provided in two eyes of a person, and reproduced images may be recognized as a 3D image.

### SUMMARY OF THE INVENTION

The present invention has been made in an effort to provide a method and apparatus for encoding video for supporting spatial, temporal, quality, and view scalability.

The present invention has been made in an effort to further provide a method and apparatus for decoding video for supporting spatial, temporal, quality, and view scalability.

The present invention has been made in an effort to further provide a video processing system for supporting spatial, temporal, quality, and view scalability.

An exemplary embodiment of the present invention provides a method of decoding video. The method includes decoding first bitstream corresponding to a base layer image based on first decoding information corresponding to an image belonging to a view different from a view to which the base layer image belongs and decoding second bitstream corresponding to an enhancement layer image based on second decoding information corresponding to the base layer image and third decoding information corresponding to an image belonging to a view different from a view to which the enhancement layer image belongs.

The base layer image and the enhancement layer image may have different spatial resolutions.

The base layer image and the enhancement layer image may have different quality resolutions.

The first decoding information, the second decoding information, and the third decoding information may include at least one of texture information, motion information, residual signal information, and decoded signal information.

The method may further include receiving single bitstream multiplexed based on a first network absolute layer (NAL) unit corresponding to the first bitstream and a second NAL unit corresponding to the second bitstream; and extracting the first bitstream and the second bitstream from the single bitstream.

A first NAL unit header corresponding to the first NAL unit may include at least one of a first spatial identifier, a first temporal identifier, a first quality identifier, and a first view identifier, a second NAL unit header corresponding to the second NAL unit may include at least one of a second spatial identifier, a second temporal identifier, a second quality identifier, and a second view identifier. The first spatial identifier, the first temporal identifier, the first quality identifier, and the first view identifier may indicate a spatial resolution, a temporal resolution, a quality resolution, and a view resolution, respectively, corresponding to the base layer image, and the second spatial identifier, the second temporal identifier, the second quality identifier, and the second view identifier may indicate a spatial resolution, a temporal resolution, a quality resolution, and a view resolution, respectively, corresponding to the enhancement layer image.

The extracting of the first bitstream may include extracting the first bitstream based on information included in the first NAL unit header and extracting the second bitstream based on information included in the second NAL unit header.

The decoding of the first bitstream may include performing an inter-view prediction of the base layer image based on the first decoding information.

The decoding of the second bitstream may include performing at least one of an inter layer texture prediction, an inter layer motion information prediction, and an inter layer residual signal prediction of the enhancement layer based on the second decoding information.

The decoding of the second bitstream may include performing an inter-view prediction of the enhancement layer image based on the third decoding information.

Another embodiment of the present invention provides a method of encoding video. The method includes generating first bitstream corresponding to a base layer image by encoding the base layer image based on first encoding information corresponding to an image belonging to a view different from a view to which the base layer image belongs and generating second bitstream corresponding to an enhancement layer image by encoding the enhancement layer image based on second encoding information corresponding to the base layer image and third encoding information corresponding to an image belonging to a view different from a view to which the enhancement layer image belongs.

The base layer image and the enhancement layer image may have different spatial resolutions.

The base layer image and the enhancement layer image may have different quality resolutions.

The first encoding information, the second encoding information, and the third encoding information may include at least one of texture information, motion information, residual signal information, and encoded signal information.

The method may further include generating single bitstream by multiplexing based on the first bitstream and the second bitstream.

The encoding of the base layer image may include performing an inter-view prediction of the base layer image based on the first encoding information.

The encoding of the enhancement layer image may include performing at least one of an inter layer texture prediction, an inter layer motion information prediction, and an inter layer residual signal prediction of the enhancement layer based on the second encoding information.

The encoding of the enhancement layer image may include performing an inter-view prediction of the enhancement layer image based on the third encoding information.

A method of encoding video according to the present invention can support spatial, temporal, quality, and view scalability.

A method of decoding video according to the present invention can support spatial, temporal, quality, and view scalability.

A video processing system according to the present invention can support spatial, temporal, quality, and view scalability.

### BRIEF DESCRIPTION OF THE DRAWINGS

FIG. 1 is a block diagram illustrating a basic configuration according to an exemplary embodiment of an image encoding apparatus.

FIG. 2 is a block diagram illustrating a basic configuration according to an exemplary embodiment of an image decoding apparatus.

FIG. 3 is a diagram illustrating a scalable video coding structure using multiple layers according to an exemplary embodiment of the present invention.

FIG. 4 is a conceptual diagram illustrating an exemplary embodiment of a prediction method in a multiview image encoding/decoding process.

FIG. 5 is a block diagram illustrating a system that encodes and decodes an image according to an exemplary embodiment of the present invention.

FIG. 6 is a flowchart illustrating an exemplary embodiment of a method of encoding an image for supporting scalability corresponding to two spatial resolutions and the N number views.

FIG. 7 is a flowchart illustrating an exemplary embodiment of a method of encoding an image for supporting scalability corresponding to two quality resolutions and the N number views.

FIG. 8 is a flowchart illustrating an exemplary embodiment of a method of encoding an image for supporting scalability corresponding to two spatial resolutions, two quality resolutions, and the N number views.

FIG. 9 is a block diagram illustrating a video encoder structure that supports scalability corresponding to two spatial resolutions and two views according to an exemplary embodiment of the present invention.

### DESCRIPTION OF EXEMPLARY EMBODIMENTS

Hereinafter, an exemplary embodiment according to the present invention will be described in detail with reference to the drawings. Further, detailed descriptions of well-known functions and structures incorporated herein may be omitted to avoid obscuring the subject matter of the present invention.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

A term such as a first and a second may be used for describing various configurations, but the configurations are not limited by the term. The terms are used for distinguishing one configuration from another configuration. For example, a first configuration may be referred to as a second configuration and a second configuration may be referred to as a first configuration without departing from the spirit or scope of the present invention.

Further, constituent elements described in an exemplary embodiment of the present invention are independently described to represent different characteristic functions, and it does not mean that each constituent element are formed with separated hardware or one software constituent unit. That is, for convenience of description, each constituent element is individually arranged and included, and at least two of constituent elements may form one constituent element or one constituent element may be divided into a plurality of constituent elements and perform a function. An integrated exemplary embodiment and a separated exemplary embodiment of each constituent element are included in the scope of the present invention when departing from the spirit of the present invention.

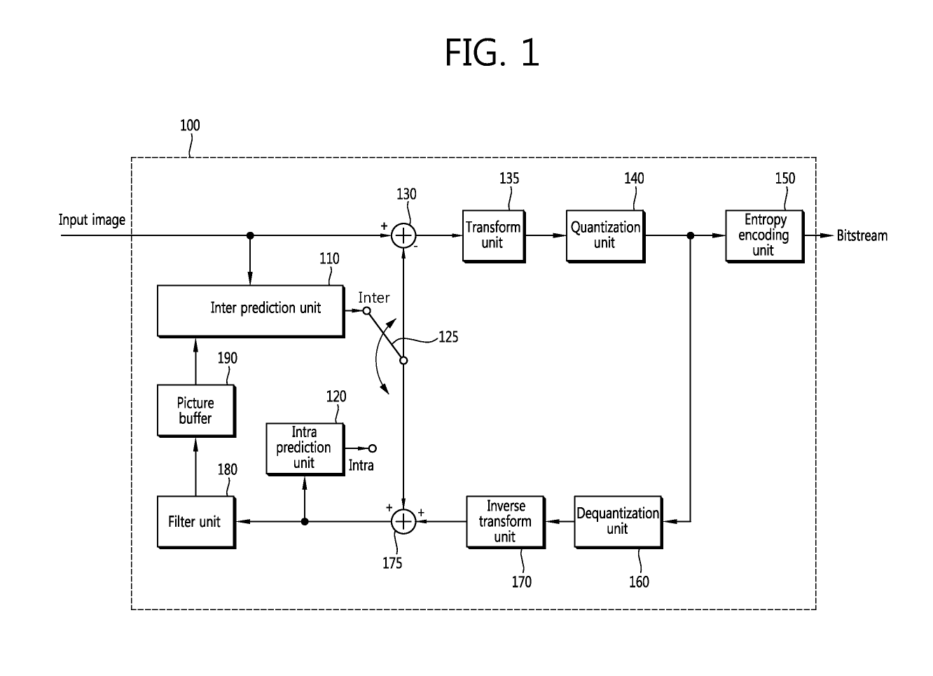

FIG. 1 is a block diagram illustrating a basic configuration according to an exemplary embodiment of an image encoding apparatus.

A method or an apparatus for encoding/decoding scalable video can be embodied by extension of a method or an apparatus for encoding/decoding a general image that does not provide scalability. Further, in a process of encoding/decoding 3D video, a process of encoding/decoding an image corresponding to each view may be performed. A block diagram of FIG. 1 illustrates an exemplary embodiment of an image encoding apparatus that may become a base of a scalable video encoding apparatus and a 3D video encoding apparatus.

Referring to FIG. 1, an image encoding apparatus 100 includes an inter prediction unit 110, an intra prediction unit 120, a switch 125, a subtractor 130, a transform unit 135, a quantization unit 140, an entropy encoding unit 150, a dequantization unit 160, an inverse transform unit 170, an adder 175, a filter unit 180, and a picture buffer 190.

The image encoding apparatus 100 may encode an input image in an intra mode or an inter mode and output bitstream. In the intra mode, the switch 125 may be switched to intra, and in the inter mode, the switch 125 may be switched to inter. The image encoding apparatus 100 may generate a prediction block of an input block of an input image and encode a difference of the input block and the prediction block.

In the intra mode, the intra prediction unit 120 may perform a spatial prediction using a pixel value of an already encoded block at a peripheral of a current block and generate a prediction block. In the inter mode, in a motion prediction process, the inter prediction unit 110 may find an area corresponding to an input block in a reference image stored at the picture buffer 190 and obtain a motion vector. The inter prediction unit 110 may perform motion compensation using the motion vector and the reference image stored at the picture buffer 190, thereby generating a prediction block. In this case, a processing unit in which a prediction is performed and a processing unit in which a prediction method and detailed contents are determined may be different. For example, when a prediction mode is determined in a PU unit, a prediction may be performed in a TU unit, and when a prediction mode is determined in a PU unit, a prediction may be performed in a TU unit.

The subtractor 130 may generate a residual block by a difference between an input block and a generated prediction block. The transform unit 135 may transform the residual block and output a transform coefficient. The quantization unit 140 may quantize the input transform coefficient according to a quantization parameter and output the quantized coefficient.

The entropy encoding unit 150 may entropy-encode the quantized coefficient according to probability distribution based on values obtained in the quantization unit 140 or an encoding parameter value obtained in an encoding process, thereby outputting bitstream.

The quantized coefficient is dequantized in the dequantization unit 160 and is inversely transformed in the inverse transform unit 170. The dequantized and inversely transformed coefficient is added to the prediction block through the adder 175, and a reconstruction block is generated.

The reconstruction block passes through the filter unit 180, and the filter unit 180 applies at least one of a deblocking filter, sample adaptive offset (SAO), and an adaptive loop filter (ALF) to the reconstruction block or a reconstruction picture. The reconstruction block, having passed through the filter unit 180 is stored at the picture buffer 190.

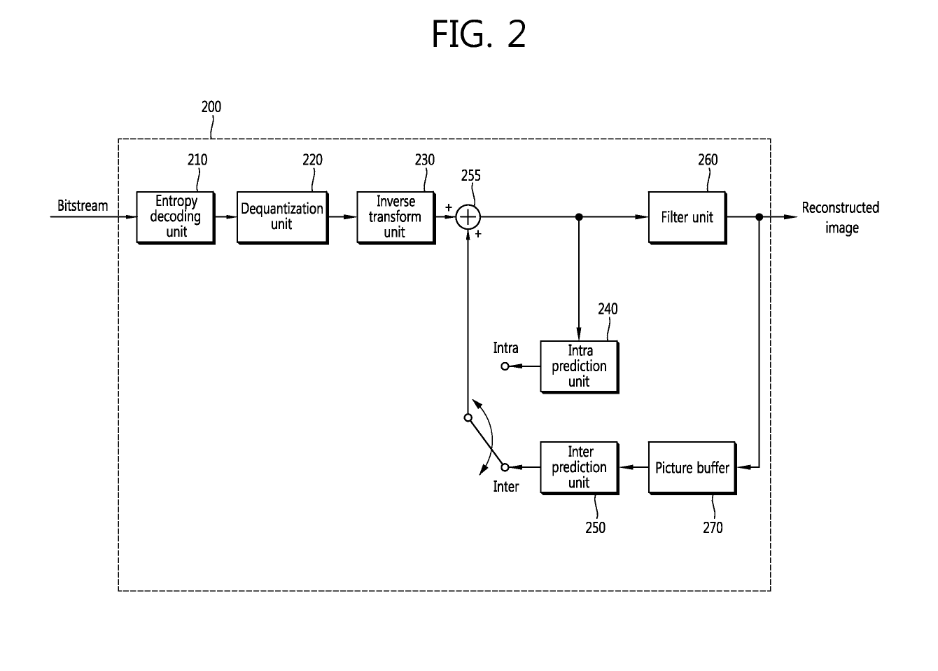

FIG. 2 is a block diagram illustrating a basic configuration according to an exemplary embodiment of an image decoding apparatus.

As described in relation to FIG. 1, a method or an apparatus for encoding/decoding scalable video is embodied by extension of a method or an apparatus for encoding/decoding a general image that does not provide scalability. Further, in a process of encoding/decoding 3D video, a process of encoding/decoding an image corresponding to each view is performed. A block diagram of FIG. 2 illustrates an exemplary embodiment of an image decoding apparatus that may become a base of a scalable video decoding apparatus and a 3D video decoding apparatus.

Referring to FIG. 2, an image decoding apparatus 200 includes an entropy decoding unit 210, a dequantization unit 220, an inverse transform unit 230, an intra prediction unit 240, an inter prediction unit 250, a filter unit 260, and a picture buffer 270.

The image decoding apparatus 200 may receive bitstream output from an encoding apparatus, decode the bitstream in an inter mode or an intra mode, and output a reconfigured image, i.e., a reconstruction image. In the intra mode, the switch may be switched to intra, and in the inter mode, the switch may be switched to inter.

The image decoding apparatus 200 may obtain a residual block reconstructed from the input bitstream, generate a prediction block, and generate a reconfigured block, i.e., a reconstruction block by adding the reconstructed residual block and the prediction block.

The entropy decoding unit 210 may entropy-decode the input bitstream according to probability distribution. By entropy-decoding, a quantized (transform) coefficient is generated.

The quantized coefficient is dequantized in the dequantization unit 220 and is inversely transformed in the inverse transform unit 230, and as the quantized coefficient is dequantized/inversely transformed, a reconstructed residual block is generated.

In the intra mode, the intra prediction unit 240 may perform a spatial prediction using a pixel value of an already encoded block at a periphery of a present block, thereby generating a prediction block. In the inter mode, the inter prediction unit 250 may perform motion compensation using a motion vector and a reference image stored at the picture buffer 270, thereby generating a prediction block. In this case, a processing unit in which a prediction is performed and a processing unit in which a prediction method and detailed contents are determined may be different. For example, when a prediction mode is determined in a PU unit, a prediction may be performed in a TU unit, and when a prediction mode is determined in a PU unit, a prediction may be performed in a TU unit.

The reconstructed residual block and the prediction block are added through an adder 255, and the added block passes through the filter unit 260. The filter unit 260 may apply at least one of a deblocking filter, SAO, and ALF to the reconstruction block or a reconstruction picture. The filter unit 260 may output a reconfigured image, i.e., a reconstructed image. The reconstructed image is stored at the picture buffer 270 and is used for an inter prediction.

Hereinafter, a block is a unit for encoding and decoding an image. When encoding and decoding an image, an encoding or decoding unit is a divided unit when dividing an image into a subdivided unit and encoding or decoding the divided image, and the encoding or decoding unit is referred to as a macro block, a coding unit (CU), a prediction unit (PU), a transform unit (TU), and a transform block. Therefore, in this specification, a block (and/or an encoding/decoding target block) indicates a coding unit, a prediction unit and/or a transform unit corresponding to the block (and/or an encoding/decoding target block). Such classification may easily performed by a person of ordinary skill in the art.

With the development of communication and image technology, various devices using image information have different performances and are used. Devices such as a mobile phone reproduce a moving picture of a relatively lower resolution based on bitstream. However, devices such as a personal computer (PC) reproduce a moving picture of a relatively high resolution.

Therefore, a method of providing an optimal moving picture service to devices of various performances is necessary. One of solutions thereof is scalable video coding (hereinafter, referred to as ‘SVC’).

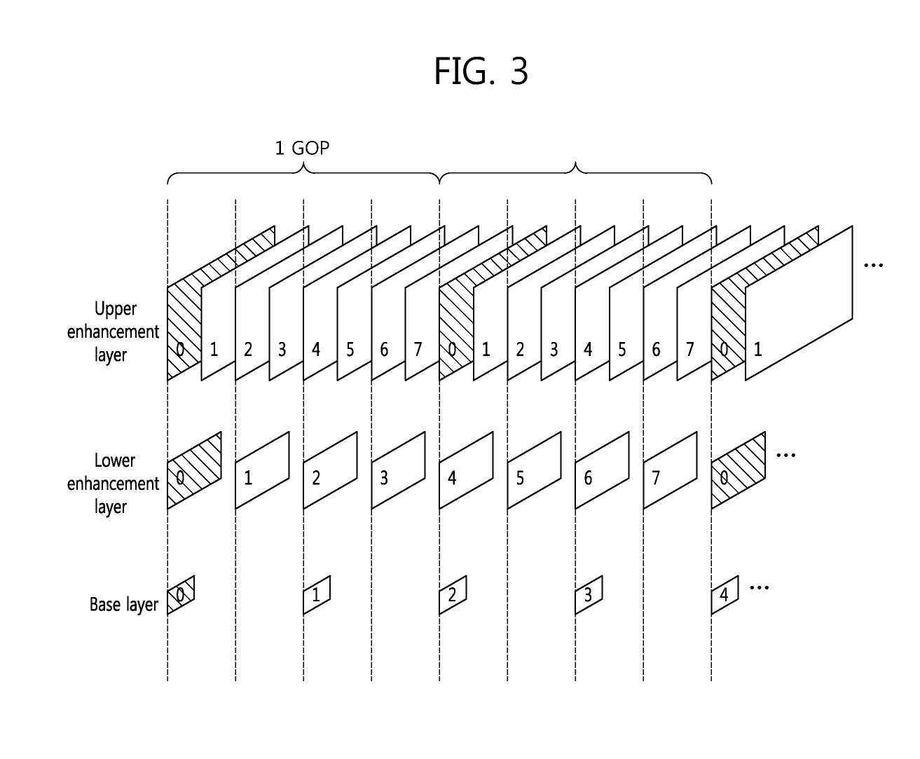

FIG. 3 is a diagram illustrating a scalable video coding structure using multiple layers according to an exemplary embodiment of the present invention. In FIG. 3, a group of picture (GOP) represents a group of pictures.

In order to transmit image data, a transmission medium is necessary, and performances thereof are different on a transmission medium basis according to various network environments. For application to such various transmission medium or network environments, a scalable video coding method may be provided.

An SVC method is a coding method of increasing an encoding/decoding performance by removing overlapping between layers using texture information, motion information, and a residual signal between layers. For example, in a scalable video encoding/decoding process, in order to improve encoding/decoding efficiency by removing overlapping between layers, an inter layer texture prediction, an inter layer motion information prediction and/or an inter layer residual signal prediction are applied. The SVC provides various scalability from spatial, temporal, and quality viewpoints according to a peripheral condition such as a transmission bit rate, a transmission error rate, and a system resource.

In order to provide bitstream that can apply to various network situations, SVC uses a multiple layer structure. For example, the SVC includes a base layer that processes image information using a general image encoding method and an enhancement layer that processes image information using together encoding information of the base layer and a general image encoding method.

A layer structure includes a plurality of spatial layers, a plurality of temporal layers, and a plurality of quality layers. Images included in different spatial layers may have different spatial resolutions, and images included in different temporal layers have different temporal resolutions (frame rate). Further, images included in different quality layers may have different qualities, for example, different signal-to-noise ratios (SNR) and/or different quantization parameter (QP) values.

Here, a layer is a set of an image and/or bitstream divided based on space (e.g., an image size), a time (e.g., an encoding order, an image output order), a quality, and complexity. Further, multiple layers may have dependency.

Referring to FIG. 3, as described above, an SVC structure includes multiple layers. FIG. 3 illustrates an example in which pictures of each layer are arranged according to a picture order count (POC). Each layer, i.e., a base layer and enhancement layers may have a characteristic of different bit rates, resolutions, and sizes. Bitstream of the base layer includes basic image information, and bitstream of the enhancement layer includes information of an image in which a quality (accurateness, size and/or frame rate) of the base layer is further improved.

Therefore, each layer may be encoded/decoded in consideration of different characteristics. For example, the encoding apparatus of FIG. 1 and the decoding apparatus of FIG. 2 may encode and decode a picture of a corresponding layer on a layer basis, as described in relation to FIGS. 1 and 2.

Further, a picture of each layer may be encoded/decoded using information of another layer. For example, a picture of each layer may be encoded/decoded through an inter layer prediction using information of another layer. Therefore, in the SVC structure, a prediction unit of the encoding apparatus and the decoding apparatus described in relation to FIGS. 1 and 2 may perform a prediction using information of another layer, i.e., a reference layer. The prediction unit of the encoding apparatus and the decoding apparatus may perform an inter layer texture prediction, an inter layer motion information prediction, and an inter layer residual signal prediction using information of another layer.

The inter layer texture prediction may predict texture of a current layer (encoding or decoding target layer) based on texture information of another layer. The inter layer motion information prediction may predict motion information of a current layer based on motion information (motion vector, reference picture) of another layer. The inter layer residual signal prediction may predict a residual signal of a current layer based on a residual signal of another layer.

In the SVC, a current layer is encoded and decoded using information of another layer and thus complexity that processes overlapped information between layers may be reduced, and an overhead that transmits overlapped information may be reduced.

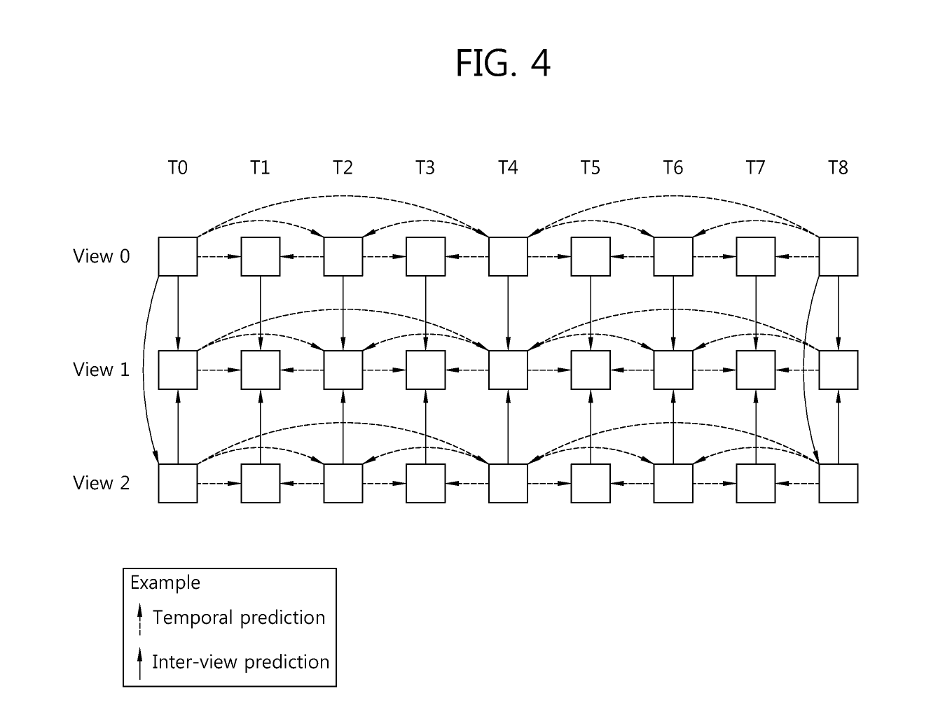

FIG. 4 is a conceptual diagram illustrating an exemplary embodiment of a prediction method in a multiview image encoding/decoding process.

In a 3D image, because the same scene may be simultaneously photographed using two or more cameras, a plurality of views may exist. Here, one view is a view of an image acquired from one camera. In an exemplary embodiment of FIG. 4, T0 to T8 indicate a time.

Referring to FIG. 4, images of three views of a view 0, a view 1, and a view 2 are provided. The number of views is not limited to three and views of two or four or more may exist. A prediction from another image within an encoding/decoding target view is a temporal prediction, and a prediction from an image within another view is an inter-view prediction. Here, the encoding/decoding target view is a view including a current encoding/decoding target image. Further, another view is a view, except for an encoding/decoding target view and is an available view at the encoding/decoding target view.

Referring to FIG. 4, in a multiview image, because images acquired at several views may be used for encoding/decoding, when encoding/decoding a current prediction target block, an inter-view prediction and a temporal prediction may be together used. In multiview image encoding/decoding, temporal overlapping is removed through a temporal prediction and overlapping within an image between views is removed through an inter-view prediction and thus encoding/decoding efficiency can be improved. That is, in a multiview image, temporal scalability and view scalability may be provided. Temporal scalability and view scalability in a multiview image may be embodied based on a hierarchical B structure, as described in relation to FIG. 4. Hereinafter, in this specification, it is assumed that a coding structure for encoding/decoding corresponds to a hierarchical B structure.

A method of coding scalable video described in relation to FIG. 3 may simultaneously or individually provide spatial, temporal, and quality scalability. Further, a 3D video coding method described in relation to FIG. 4 may provide temporal and view scalability. However, view scalability according to an exemplary embodiment of FIG. 4 is provided independently of spatial, temporal, and quality scalability according to the exemplary embodiment of FIG. 3 and thus view scalability according to an exemplary embodiment of FIG. 4 has a structure having difficulty in using by coupling to spatial scalability and quality scalability provided in the exemplary embodiment of FIG. 3. Therefore, when providing a 3D video service, in order to change a spatial resolution and a quality resolution according to a specification of a terminal, a problem that transcoding and/or a separate encoding/decoding process should be performed may occur.

Therefore, when providing a 3D video service, while providing another spatial, temporal, and quality resolutions according to a terminal specification through an integrated encoding process and/or an integrated decoding process, an image encoding/decoding method that can selectively provide a view necessary for generating a 3D image among a plurality of views is requested. For this purpose, an image encoding/decoding method that can simultaneously support spatial, quality, and temporal scalability or that can simultaneously support spatial, temporal, quality, and view scalability is provided.

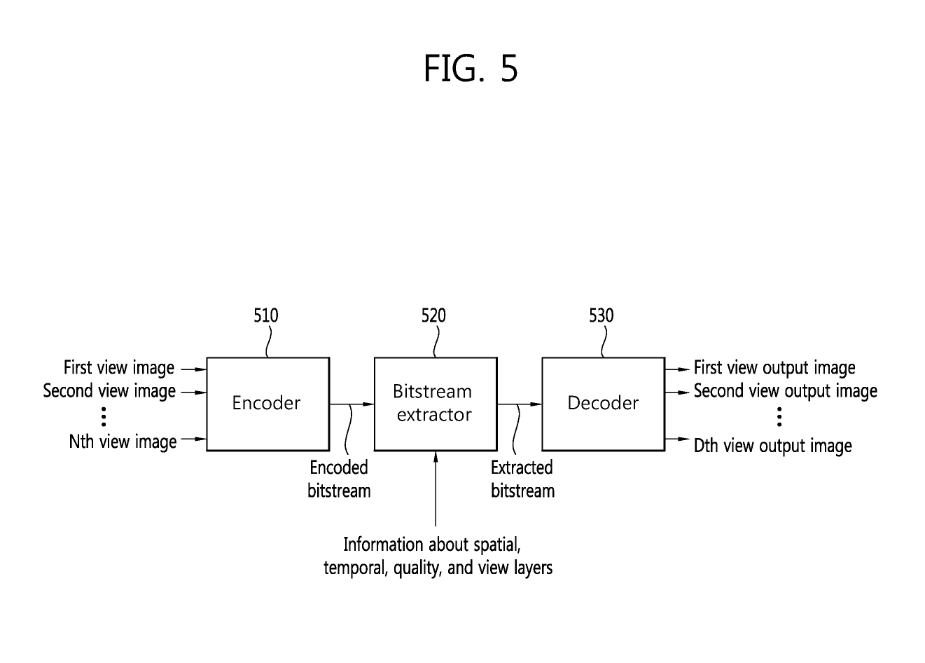

FIG. 5 is a block diagram illustrating a system that encodes and decodes an image according to an exemplary embodiment of the present invention. The system according to the present invention includes an encoder 510, a bitstream extractor 520, and a decoder 530.

Referring to FIG. 5, the N number of images (N is the natural number) simultaneously acquired by the N number of cameras may be input to the encoder 510. In this case, because the N number of cameras may have different views, the N number of images may be an image acquired at different views. In an exemplary embodiment of FIG. 5, the N number of images are referred to as a first view image, a second view image, . . . , the (N−1)th view image, and the Nth view image. For example, the N number of images may have a spatial resolution of A1×A2 (e.g., 1920×1080 in HD) and a temporal resolution of 30 fps (frame/sec).

The encoder 510 of FIG. 5 may support spatial, temporal, quality, and view scalability. Therefore, the encoder 510 may receive the N number of images having different views and output one encoded bitstream. Further, the encoder 510 may encode information about space, time, quality, and view layers generated in an encoding process, include the encoded information in bitstream, and transmit the bitstream. Here, as an example, the information may be information that indicates an uppermost level layer corresponding to spatial, temporal, quality and/or view resolutions necessary for generating a 3D image.

The bitstream extractor 520 of FIG. 5 may support spatial, temporal, quality, and view scalability. Therefore, the bitstream extractor 520 may receive bitstream transmitted from the encoder 510 and output bitstream including an uppermost level layer corresponding to a spatial resolution, a temporal resolution, a quality resolution, and the view number necessary for generating a 3D image. In this case, as an example, the spatial resolution may be A1×A2, the temporal resolution may be B fps, the quality resolution may be C, and the view number may be D. Here, A1, A2, B, and C are the random number, and D is the random natural number. In this case, the bitstream extractor 520 may use information about spatial, temporal, quality, and view layers transmitted from the encoder 510.

Bitstream output from the bitstream extractor 520 may be decoded through the decoder 530. The decoder 530 shown in FIG. 5 may support spatial, temporal, quality, and view scalability. Therefore, the decoder 530 may decode bitstream output from the bitstream extractor 520, thereby outputting the D number of decoded images each having a spatial resolution of A1×A2, a temporal resolution of B fps, and a quality resolution of C. The D number of decoded images may have different views and correspond to a signal of an YUV format. Further, the D number of images output from the decoder 530 each corresponds to 1 number of sub bitstream. That is, bitstream input to the decoder 530 is formed with the D number of sub bitstream.

In the exemplary embodiment of FIG. 5, the D number of images are represented by a first view output image, a second view output image, . . . , the D view output image. In this case, the D number of images having different views each has a spatial resolution of A1×A2, a temporal resolution of B fps, and a quality resolution of C.

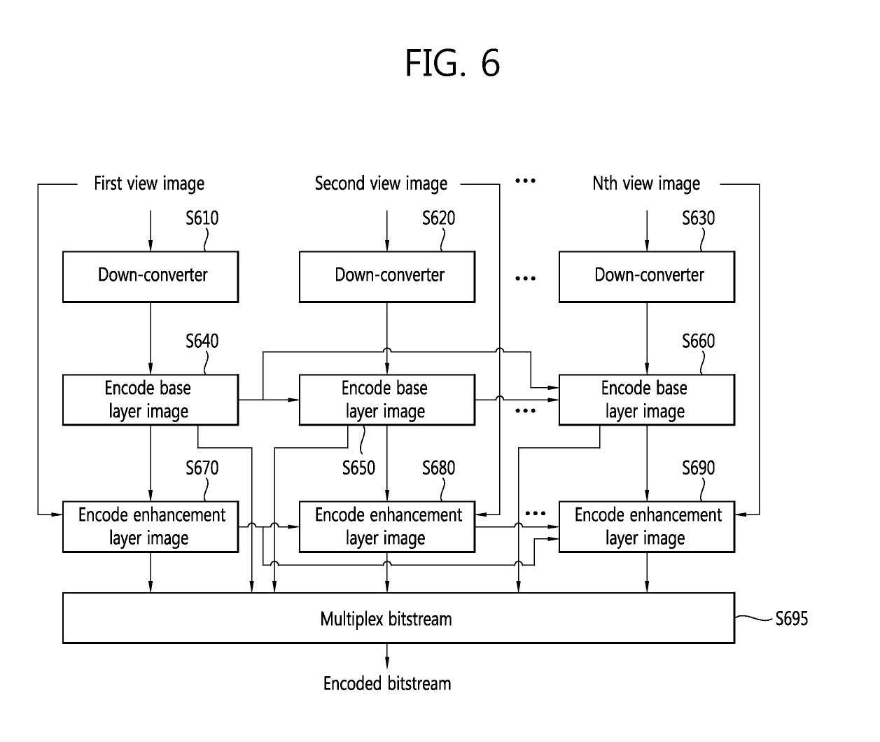

FIG. 6 is a flowchart illustrating an exemplary embodiment of a method of encoding an image for supporting scalability corresponding to two spatial resolutions and the N number views. Here, N is the natural number of 2 or more.

Temporal scalability and view scalability may be embodied based on a hierarchical B structure. A method of providing temporal scalability and view scalability based on a hierarchical B structure was described in relation to FIG. 4 and therefore, in a description of FIG. 6, a detailed description thereof will be omitted.

In an exemplary embodiment of FIG. 6, the N number of images acquired from different views are encoded. In an exemplary embodiment of FIG. 6, the N number of images are referred to as a first view image, a second view image, . . . , the Nth view image. In the following exemplary embodiment, methods are described based on a flowchart with a series of steps, but the present invention is not limited to order of steps, and some step may be performed in step or order different from that to be described later or may simultaneously be performed.

Further, an exemplary embodiment of FIG. 6 describes two spatial layers, but the present invention is not limited thereto. Even in a case in which two spatial layers exist, the following exemplary embodiments may be performed with the same method as or a method similar to that of an encoding process.

Referring to FIG. 6, the encoder may down-convert a first view image to correspond to a resolution of a base layer to be encoded (S610). By down-converting the first view image, the encoder may generate a base layer image corresponding to the first view image. Hereinafter, in an exemplary embodiment of FIG. 6, a base layer image corresponding to the first view image is referred to as a first base layer image.

When the first base layer image is generated, the encoder may encode the first base layer image (S640), as in the exemplary embodiment described in relation to FIG. 1. In this case, in an encoding process, in order to remove spatial overlapping and/or temporal overlapping within the first base layer image, the encoder may perform an inter prediction and/or an intra prediction described in relation to FIG. 1.

The encoder may encode an enhancement layer image (hereinafter, referred to as a ‘first enhancement layer image’) corresponding to the first view image based on the first view image (S670). In this case, in an encoding process, in order to remove spatial overlapping and/or temporal overlapping within the first enhancement layer image, as in the first base layer image, the encoder may perform an inter prediction and/or an intra prediction described in relation to FIG. 1.

Further, when encoding the first enhancement layer image, in order to remove overlapping between the first enhancement layer and a lower layer (e.g., a first base layer), the encoder may use encoding related information of a lower spatial layer (e.g., a first base layer). Here, the encoding related information of the lower spatial layer may include intra related information (e.g., texture information), inter related information (e.g., motion information), residual signal information, and decoded signal information. In this case, in order to remove overlapping between layers, the encoder may perform an inter layer texture prediction, an inter layer motion information prediction and/or an inter layer residual signal prediction based on the encoding related information of the lower spatial layer.

Referring again to FIG. 6, the encoder may down-convert a second view image to correspond to a resolution of a base layer to be encoded (S620). By down-converting a second view image, the encoder may generate a base layer image corresponding to the second view image. Hereinafter, in an exemplary embodiment of FIG. 6, the base layer image corresponding to the second view image is referred to as a second base layer image.

When the second base layer image is generated, the encoder may encode the second base layer image (S650). In this case, as in the first base layer image, in an encoding process, in order to remove spatial overlapping and/or temporal overlapping within the second base layer image, the encoder may perform an inter prediction and/or an intra prediction described in relation to FIG. 1.

Further, when encoding the second base layer image, in order to remove overlapping between the second base layer image and the first base layer image (an image having a view from different that of the second base layer image), the encoder may use encoding related information of the first base layer image. Here, the encoding related information of the first base layer may include intra related information, inter related information, residual signal information, and decoded signal information. In this case, by performing an inter-view prediction of a picture, a block and/or other encoding related information belonging to the second base layer image based on the encoding related information of the first base layer, the encoder may remove overlapping between views.

The encoder may encode an enhancement layer image (hereinafter, referred to as a ‘second enhancement layer image’) corresponding to the second view image based on the second view image (S680). In this case, in an encoding process, in order to remove spatial overlapping and/or temporal overlapping within the second enhancement layer image, as in the second base layer image, the encoder may perform an inter prediction and/or an intra prediction described in relation to FIG. 1.

Further, when encoding a second enhancement layer image, in order to remove overlapping between the second enhancement layer and a subordinate layer (e.g., a second base layer), the encoder may use encoding related information of a lower spatial layer (e.g., a second base layer). Here, the encoding related information of the lower spatial layer may include intra related information (e.g., texture information), inter related information (e.g., motion information), residual signal information, and decoded signal information. In this case, in order to remove overlapping between layers, the encoder may perform an inter layer texture prediction, an inter layer motion information prediction and/or an inter layer residual signal prediction based on the encoding related information of the lower spatial layer.

Further, when encoding the second enhancement layer image, in order to remove overlapping between the second enhancement layer image and the first enhancement layer image (an image having a view from different that of the second enhancement layer image), the encoder may use encoding related information of the first enhancement layer image. Here, the encoding related information of the first enhancement layer image may include intra related information, inter related information, residual signal information, and decoded signal information. In this case, as the encoder may perform an inter-view prediction of a picture, a block and/or other encoding related information belonging to the second enhancement layer image based on the encoding related information of the first enhancement layer, the encoder may remove overlapping between views of the second enhancement layer image.

Referring again to FIG. 6, the encoder may encode each of a third view image to the Nth view image. In this case, the encoder may encode each of the third view image to the Nth view image with the same method as or a method similar to that in the second view image. However, in the second view image, in order to remove overlapping between views, only encoding related information of the first view image is used, but in the Nth (N is the natural number of 3 or more) view image, in order to remove overlapping between views, all encoding related information of the first view image to the (N−1)th view image may be used. That is, the encoder may encode the Nth view image based on at least one of the encoding related information of the first view image to the (N−1)th view image.

For example, when encoding the Nth view image, the encoder may down-convert the Nth view image, thereby generating an Nth base layer image corresponding to the Nth view image (S630).

When the Nth base layer image is generated, the encoder may encode the Nth base layer image (S660). In this case, in an encoding process, in order to remove spatial overlapping and/or temporal overlapping of the Nth base layer image, the encoder may perform an inter prediction and/or an intra prediction described in relation to FIG. 1.

Further, when encoding the Nth base layer image, the encoder may perform an inter-view prediction based on encoding related information of a base layer image corresponding to an image of different views, thereby removing overlapping between views. In this case, a base layer image corresponding to the image of different views may be at least one of a first base layer image to the (N−1)th base layer image. An exemplary embodiment about encoding related information has been described above and therefore a description thereof will be omitted.

The encoder may encode an enhancement layer image (hereinafter, referred to as an ‘Nth enhancement layer image’) corresponding to the Nth view image based on the Nth view image (S690). In this case, in an encoding process, in order to remove spatial overlapping and/or temporal overlapping of the Nth enhancement layer image, the encoder may perform an inter prediction and/or an intra prediction described in relation to FIG. 1. Further, the encoder may remove overlapping between layers using encoding related information of a lower spatial layer corresponding to the Nth enhancement layer.

Further, when encoding the Nth enhancement layer image, the encoder may perform an inter-view prediction based on the encoding related information of an enhancement layer image corresponding to images of different views, thereby removing overlapping between views. In this case, an enhancement layer image corresponding to the images of different views may be at least one of a first enhancement layer image to the (N−1)th enhancement layer image. An exemplary embodiment about encoding related information has been described above and therefore a description thereof will be omitted.

Referring again to FIG. 6, by multiplexing bitstream corresponding to a first view image to bitstream corresponding to the Nth view image, the encoder may generate encoded single bitstream (S695). The generated bitstream is transmitted to a decoder.

According to the foregoing exemplary embodiment, spatial scalability and view scalability may be simultaneously provided.

An exemplary embodiment of FIG. 6 was described from a viewpoint of the encoder, but the present invention is not limited thereto. In FIG. 6, exemplary embodiments of prediction and reference processes applied to remove spatial overlapping and overlapping between views may be applied to a decoder with the same method as or a method similar to that of the encoder. For example, in a process of S640 to S690, prediction processes applied to remove overlapping within a layer, overlapping between layers, and overlapping between views may be applied to a decoder with the same method.

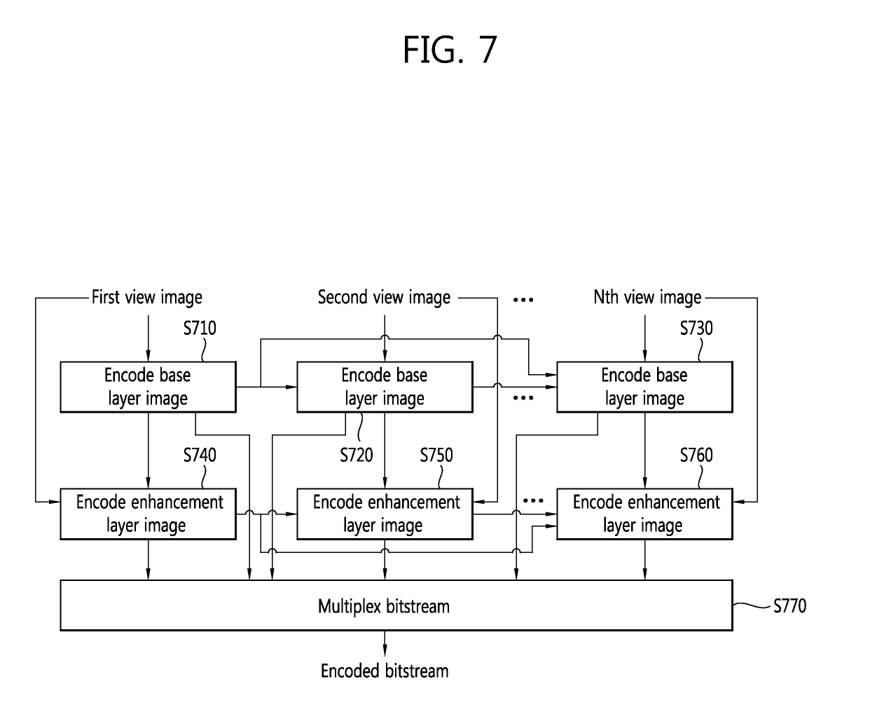

FIG. 7 is a flowchart illustrating an exemplary embodiment of a method of encoding an image for supporting scalability corresponding to two quality resolutions and the N number views. Here, N is the natural number of 2 or more.

In an exemplary embodiment of FIG. 7, the N number of images acquired from different views may be encoded. In the exemplary embodiment of FIG. 7, the N number of images are referred to as a first view image, a second view image, . . . , the Nth view image. In the following exemplary embodiment, methods are described based on a flowchart with a series of steps, but the present invention is not limited to order of steps, and some step may be performed in step or order different from that to be described later or may simultaneously be performed.

Further, the exemplary embodiment of FIG. 7 describes two quality layers, but the present invention is not limited thereto. Even in a case in which two quality layers exist, the following exemplary embodiments may be performed with the same method as or a method similar to that of an encoding process.

In a scalable encoding process that supports a plurality of quality resolutions, in order to generate an image of each of a multiple layers, a down-converting process may not be performed, unlike the exemplary embodiment of FIG. 6. By applying a quantization parameter (QP) value smaller than that of an image of a lower layer to an image of a upper layer, quality scalability may be provided. That is, when encoding the upper layer image, the encoder may apply a QP value smaller than that of the lower layer image. Here, as quantization step has a large magnitude, QP has a large value, and as quantization step has a small magnitude, QP has a small value. When quantization step has a large magnitude, many quantization errors may occur and thus as a QP value is small, a quality resolution of an image increases.

Referring to FIG. 7, the encoder may encode a base layer image (hereinafter, referred to as a ‘first base layer image’) corresponding to a first view image (S710), as in the exemplary embodiment described in relation to FIG. 1. In this case, in an encoding process, in order to remove spatial overlapping and/or temporal overlapping within the first base layer image, the encoder may perform an inter prediction and/or an intra prediction described in relation to FIG. 1.

The encoder may encode an enhancement layer image (hereinafter, referred to as a ‘first enhancement layer image’) corresponding to the first view image based on the first view image (S740). In this case, as in the first base layer image, in an encoding process, in order to remove spatial overlapping and/or temporal overlapping within the first enhancement layer image, the encoder may perform an inter prediction and/or an intra prediction described in relation to FIG. 1.

Further, when encoding the first enhancement layer image, in order to remove overlapping between the first enhancement layer and a lower layer (e.g., a first base layer), the encoder may use encoding related information of a lower quality layer (e.g., a first base layer). Here, the encoding related information of the lower quality layer may include intra related information (e.g. texture information), inter related information (e.g., motion information), residual signal information, and decoded signal information. In this case, in order to remove overlapping between layers, the encoder may perform an inter layer texture prediction, an inter layer motion information prediction and/or an inter layer residual signal prediction based on the encoding related information of the lower quality layer.

Referring again to FIG. 7, the encoder may encode a base layer image (hereinafter, referred to as a ‘second base layer image’) corresponding to a second view image (S720). In this case, as in the first base layer image, in an encoding process, in order to remove spatial overlapping and/or temporal overlapping within the second base layer image, the encoder may perform an inter prediction and/or an intra prediction described in relation to FIG. 1.

Further, when encoding the second base layer image, in order to remove overlapping between the second base layer image and the first base layer image (an image having a view from different that of the second base layer image), the encoder may use encoding related information of the first base layer image. Here, the encoding related information of the first base layer may include intra related information, inter related information, residual signal information, and decoded signal information. In this case, as the encoder may perform an inter-view prediction of a picture, a block and/or other encoding related information belonging to the second base layer image based on the encoding related information of the first base layer, the encoder may remove overlapping between views.

The encoder may encode an enhancement layer image (hereinafter, referred to as a ‘second enhancement layer image’) corresponding to the second view image based on the second view image (S750). In this case, as in the second base layer image, in an encoding process, in order to remove spatial overlapping and/or temporal overlapping within the second enhancement image, the encoder may perform an inter prediction and/or an intra prediction described in relation to FIG. 1.

Further, when encoding the second enhancement layer image, in order to remove overlapping between the second enhancement layer and a lower layer (e.g., a second base layer), the encoder may use encoding related information of a lower quality layer (e.g., a second base layer). Here, the encoding related information of the lower quality layer may include intra related information (e.g., texture information), inter related information (e.g., motion information), residual signal information, and decoded signal information. In this case, in order to remove overlapping between layers, the encoder may perform an inter layer texture prediction, an inter layer motion information prediction and/or an inter layer residual signal prediction based on the encoding related information of a lower quality layer.

Further, when encoding the second enhancement layer image, in order to remove overlapping between the second enhancement layer image and the first enhancement layer image (an image having a view from different that of the second enhancement layer image), the encoder may use encoding related information of the first enhancement layer image. Here, the encoding related information of the first enhancement layer image may include intra related information, inter related information, residual signal information, and decoded signal information. In this case, as the encoder may perform an inter-view prediction of a picture, a block and/or other encoding related information belonging to the second enhancement layer image based on the encoding related information of the first enhancement layer, the encoder may remove overlapping between views of the second enhancement layer image.

Referring again to FIG. 7, the encoder may encode each of a third view image to the Nth view image. In this case, the encoder may encode each of the third view image to the Nth view image with the same method as or a method similar to that in the second view image. However, in the second view image, in order to remove overlapping between views, only encoding related information of the first view image is used, but in the Nth (N is the natural number of 3 or more) view image, in order to remove overlapping between views, all encoding related information of the first view image to the (N−1)th view image may be used. That is, the encoder may encode the Nth view image based on at least one of the encoding related information of the first view image to the (N−1)th view image.

For example, when encoding the Nth view image, the encoder may encode an Nth base layer image corresponding to the Nth view image (S730). In this case, in an encoding process, in order to remove spatial overlapping and/or temporal overlapping within the Nth base layer image, the encoder may perform an inter prediction and/or an intra prediction described in relation to FIG. 1.

Further, when encoding the Nth base layer image, the encoder may perform an inter-view prediction based on encoding related information of a base layer image corresponding to an image of different views, thereby removing overlapping between views. In this case, a base layer image corresponding to the image of different views may be at least one of a first base layer image to the (N−1)th base layer image. An exemplary embodiment about encoding related information has been described above and therefore a description thereof will be omitted.

The encoder may encode an enhancement layer image (hereinafter, referred to as an ‘Nth enhancement layer image’) corresponding to the Nth view image based on the Nth view image (S760). In this case, in an encoding process, in order to remove spatial overlapping and/or temporal overlapping within the Nth enhancement layer image, the encoder may perform an inter prediction and/or an intra prediction described in relation to FIG. 1. Further, the encoder may remove overlapping between layers using encoding related information of a lower quality layer corresponding to the Nth enhancement layer.

Further, when encoding the Nth enhancement layer image, the encoder may perform an inter-view prediction based on encoding related information of an enhancement layer image corresponding to images of different views, thereby removing overlapping between views. In this case, an enhancement layer image corresponding to the images of different views may be at least one of a first enhancement layer image to the (N−1)th enhancement layer image. An exemplary embodiment about encoding related information has been described above and therefore a description thereof will be omitted.

Referring again to FIG. 7, by multiplexing the first bitstream corresponding to a first view image to the Nth bitstream corresponding to the Nth view image, the encoder may generate encoded single bitstream (S770). The generated bitstream is transmitted to a decoder.

According to the foregoing exemplary embodiment, spatial scalability and view scalability may be simultaneously provided.

An exemplary embodiment of FIG. 7 was described from a viewpoint of the encoder, but the present invention is not limited thereto. In FIG. 7, exemplary embodiments of prediction and reference processes applied to remove spatial overlapping and overlapping between views may be applied to a decoder with the same method as or a method similar to that in an encoder. For example, in a process of S710 to S760, prediction processes applied to remove overlapping within a layer, overlapping between layers, and overlapping between views may be applied to a decoder with the same method.

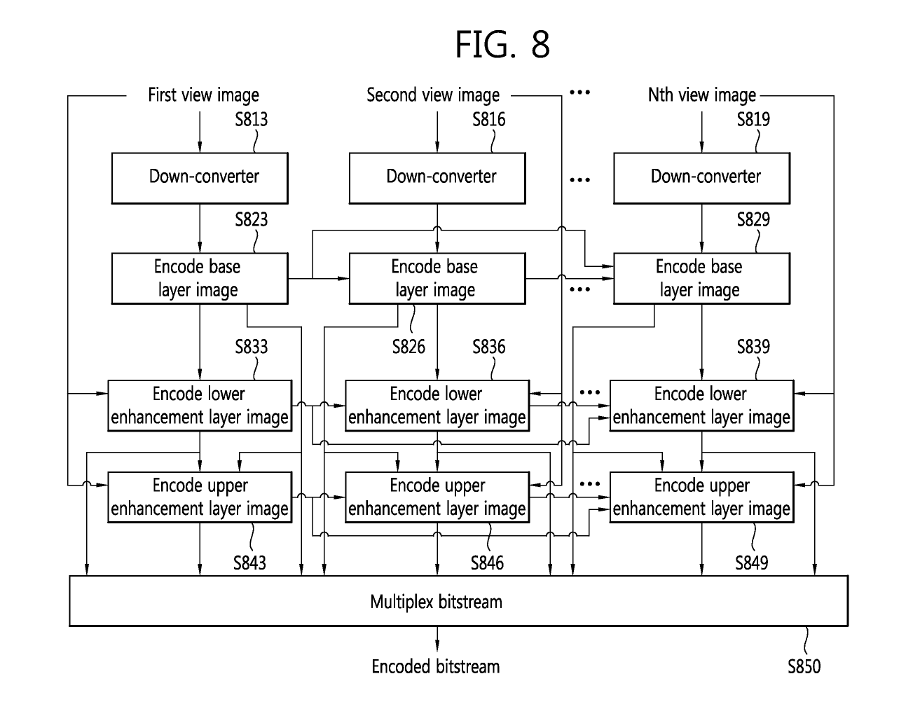

FIG. 8 is a flowchart illustrating an exemplary embodiment of a method of encoding an image for supporting scalability corresponding to two spatial resolutions, two quality resolutions, and the N number views. Here, N is the natural number of 2 or more.

In an exemplary embodiment of FIG. 8, the N number of images acquired from different views may be encoded. In the exemplary embodiment of FIG. 8, the N number of images are referred to as a first view image, a second view image, . . . , the Nth view image. In the following exemplary embodiment, methods are described based on a flowchart with a series of steps, but the present invention is not limited to order of steps, and some step may be performed in step or order different from that to be described later or may simultaneously be performed.

Further, the exemplary embodiment of FIG. 8 describes two spatial layers and two quality layers, but the present invention is not limited thereto. Even in a case in which two spatial layers and two quality layers exist, the following exemplary embodiments may be performed with the same method as or in a method similar to that in an encoding process.

In the exemplary embodiment of FIG. 8, by down-converting each of a first view image to the Nth view image, a base layer image is generated. Further, in the exemplary embodiment of FIG. 8, two enhancement layers exist. In the exemplary embodiment of FIG. 8, a layer corresponding to a lower layer of two enhancement layers is referred to as a lower enhancement layer, and a layer corresponding to a upper layer of two enhancement layers is referred to as a upper enhancement layer.

A base layer image has a spatial resolution lower than that of the lower enhancement layer and the upper enhancement layer, and the lower enhancement layer and the upper enhancement layer have the same spatial resolution. Therefore, in the exemplary embodiment of FIG. 8, two spatial resolutions may be supported. Further, when encoding the upper enhancement layer, the encoder may apply a QP value smaller than that of the lower enhancement layer image. In this case, in the exemplary embodiment of FIG. 8, two quality resolutions are supported. Therefore, an encoding process of FIG. 8 may support all of spatial, quality, and view scalability.

Referring to FIG. 8, by down-converting the first view, the encoder may generate a base layer image (hereinafter, referred to as a ‘first base layer image’) corresponding to the first view image (S813). When the first base layer image is generated, the encoder may encode the first base layer image (S823), as in the exemplary embodiment described in relation to FIG. 1. Further, the encoder may encode a first lower enhancement layer corresponding to the first view image (S833) and encode a first upper enhancement layer image corresponding to the first view image (S843). In this case, in order to remove overlapping between layers, the encoder may encode based on encoding related information of a lower layer. A detailed encoding process corresponding to each step is similar to that in the exemplary embodiment of FIGS. 6 and 7 and therefore a description thereof will be omitted.

Referring again to FIG. 8, by down-converting a second view image, the encoder may generate a base layer image (hereinafter, referred to as a ‘second base layer image’) corresponding to the second view image (S816). When the second base layer image is generated, the encoder may encode the second base layer image (S826). In this case, in order to remove overlapping between views, the encoder may encode based on the encoding related information of a first base layer.

The encoder may encode a second lower enhancement layer image corresponding to the second view image (S836). In this case, in order to remove overlapping between layers, the encoder may encode based on the encoding related information of a lower layer, and in order to remove overlapping between views, the encoder may encode based on the encoding related information of the first lower enhancement layer. Further, the encoder may encode the second upper enhancement layer image corresponding to the second view image (S846). In this case, in order to remove overlapping between layers, the encoder may encode based on the encoding related information of a lower layer, and in order to remove overlapping between views, the encoder may encode based on the encoding related information of the first upper enhancement layer.

A detailed encoding process corresponding to each step for encoding a second view image is similar to that in the exemplary embodiment of FIGS. 6 and 7 and therefore a description thereof will be omitted.

Referring again to FIG. 8, the encoder may encode each of a third view image to the Nth view image. In this case, the encoder may encode each of the third view image to the Nth view image with the same method as or a method similar to that in the second view image. However, in the second view image, in order to remove overlapping between views, only encoding related information of the first view image is used, but in the Nth (N is the natural number of 3 or more) view image, in order to remove overlapping between views, all encoding related information of the first view image to the (N−1)th view image may be used. That is, the encoder may encode the Nth view image based on at least one of the encoding related information of the first view image to the (N−1)th view image.

For example, when encoding the Nth view image, the encoder may down-convert the Nth view image, thereby generating the Nth base layer image corresponding to the Nth view image (S819). When the Nth base layer image is generated, the encoder may encode the Nth base layer image (S829). In this case, in order to remove overlapping between views, the encoder may encode based on encoding related information of a base layer image corresponding to images of different views.

The encoder may encode the Nth lower enhancement layer image corresponding to the Nth view image (S839). In this case, in order to remove overlapping between layers, the encoder may encode based on the encoding related information of a lower layer, and in order to remove overlapping between views, the encoder may encode based on the encoding related information of a lower enhancement layer image corresponding to images of different views. Further, the encoder may encode the Nth upper enhancement layer image corresponding to the Nth view image (S849). In this case, in order to remove overlapping between layers, the encoder may encode based on encoding related information of a lower layer, and in order to remove overlapping between views, the encoder may encode based on the encoding related information of a upper enhancement layer image corresponding to images of different views.

A detailed encoding process corresponding to each step for encoding the Nth view image is similar to that in the exemplary embodiment of FIGS. 6 and 7 and therefore a description thereof will be omitted.

Referring again to FIG. 8, by multiplexing bitstream corresponding to a first view image to bitstream corresponding to the Nth view image, the encoder may generate encoded single bitstream (S850). The generated bitstream is transmitted to a decoder.

According to the foregoing exemplary embodiment, spatial scalability, quality scalability, and view scalability may be simultaneously provided.

An exemplary embodiment of FIG. 8 was described from a viewpoint of the encoder, but the present invention is not limited thereto. In FIG. 8, exemplary embodiments of prediction and reference processes applied to remove spatial overlapping and overlapping between views may be applied to a decoder with the same method as or a method similar to that of an encoder. For example, in a process of S823 to S849, prediction processes applied to remove overlapping within a layer, overlapping between layers, and overlapping between views may be applied to a decoder with the same method.

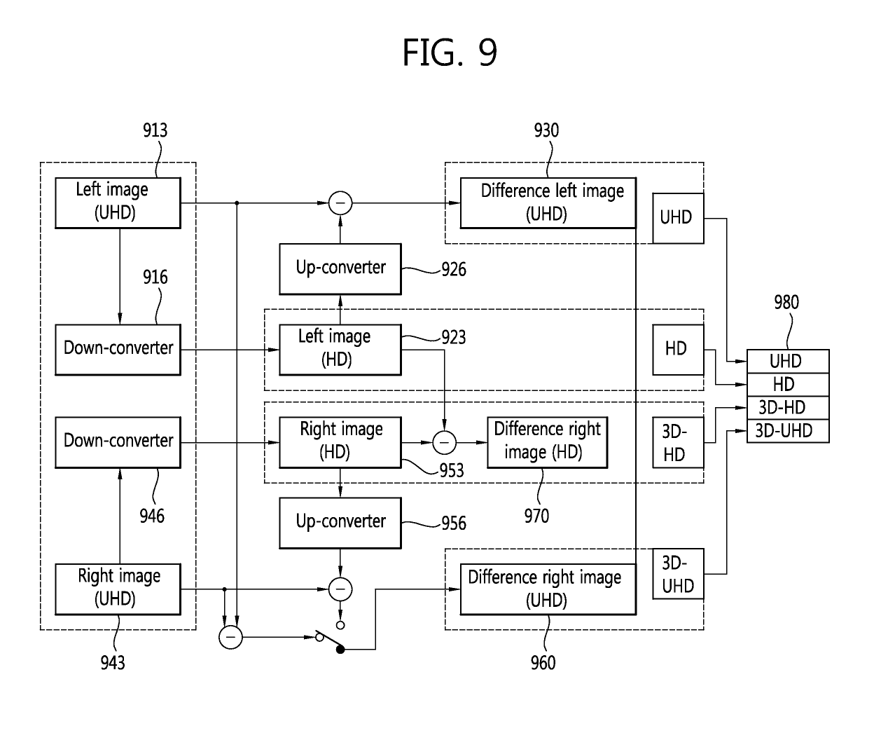

FIG. 9 is a block diagram illustrating a video encoder structure that supports scalability corresponding to two spatial resolutions and two views according to an exemplary embodiment of the present invention.

In an exemplary embodiment of FIG. 9, two images acquired from different views may be encoded. In the exemplary embodiment of FIG. 9, the two images are referred to as a left image 913 and a right image 943. Here, the left image 913 and the right image 943 correspond to an ultra high definition (UHD) image.

Referring to FIG. 9, a down-converter 916 may down-convert the left image 913 to correspond to a resolution of a base layer to be encoded. By down-converting the left image 913, the down-converter 916 may generate a base layer image 923 corresponding to the left image 913. Hereinafter, in an exemplary embodiment of FIG. 9, the base layer image 923 corresponding to the left image 913 is referred to as a ‘base layer left image’. Here, the base layer left image corresponds to a high definition (HD) image.

An up-converter 926 may up-convert the base layer left image 923. In this case, the encoder may derived a difference left image 930 corresponding to a difference between the left image 913 and the up-converted base layer left image 923 and generate bitstream corresponding to the left image 913 by encoding the difference left image 930. In FIG. 9, bitstream corresponding to the left image 913 is represented with UHD. Further, the encoder may generate bitstream corresponding to the base layer left image 923 by encoding the base layer left image 923. In FIG. 9, bitstream corresponding to the base layer left image 923 is represented with HD.

Referring again to FIG. 9, the down-converter 946 may down-convert the right image 943 to correspond to a resolution of a base layer to be encoded. By down-converting the right image 943, the down-converter 946 may generate a base layer image 953 corresponding to the right image 943. Hereinafter, in an exemplary embodiment of FIG. 9, the base layer image 953 corresponding to the right image 943 is referred to as a ‘base layer right image’. Here, the base layer right image corresponds to a high definition (HD) image.

An up-converter 956 may up-convert the base layer right image 943. In this case, the encoder may derived a difference right image 960 corresponding to the right image 943 by a difference between the right image 943 and the left image 913 or a difference between the right image 943 and the up-converted base layer right image 953. The encoder may generate bitstream corresponding to the right image 943 by encoding the difference right image 960. In FIG. 9, bitstream corresponding to the right image 943 is represented with 3D-UHD.

Further, the encoder may derived a ‘base layer difference right image 970’ corresponding to the base layer right image 953 by a difference between the base layer right image 953 and the base layer left image 923. In this case, the encoder may encode the base layer difference right image 970, thereby generating bitstream corresponding to the base layer right image 953. In FIG. 9, bitstream corresponding to the base layer right image 953 is represented with 3D-HD.

The encoder may output single bitstream 980 by multiplexing the generated bitstream UHD, HD, 3D-HD, and 3D-UHD. In this case, as an example, the output single bitstream 980 has a form in which network abstraction layer units (NAL unit) corresponding to each layer are multiplexed. In this case, in order to represent that each NAL unit includes encoding/decoding related information of some layer, an NAL unit header corresponding to the each NAL unit may include a spatial identifier representing a spatial resolution, a temporal identifier representing a temporal resolution, a quality identifier representing a quality resolution, and a view identifier representing a view resolution.

Further, the encoder may transmit an identifier indicating an uppermost level layer corresponding to spatial, temporal, quality and/or view resolutions necessary for generating a 3D image. In this case, a bitstream extractor may extract bitstream necessary for generating a 3D image from the single bitstream 980 based on an identifier indicating the uppermost level layer and information included in each NAL unit header. Here, the extracted bitstream corresponds to bitstream including an uppermost level layer corresponding to a spatial resolution, a temporal resolution, a quality resolution, and the view number necessary for generating a 3D image.

The decoder may decode bitstream encoded through the above-described encoding process.

For example, it is assumed that images of the N number (here, N is the natural number of 2 or more) acquired from different views are decoded. In this case, the N number of images are referred to as a first view image, a second view image, . . . , the Nth view image.

In this case, the decoder may decode a first base layer image corresponding to a first view image based on information transmitted from the encoder. In this case, the decoder may perform an inter prediction and/or an intra prediction described in relation to FIG. 2. Further, the decoder may decode a first enhancement layer image corresponding to a first view image. In this case, the decoder may perform an inter prediction and/or an intra prediction described in relation to FIG. 2 and may perform an inter layer texture prediction, an inter layer motion information prediction and/or an inter layer residual signal prediction based on encoding/decoding related information of a lower layer.

When decoding a plurality of views, the decoder may decode a second base layer image corresponding to a second view image. In this case, the decoder may perform an inter prediction and/or an intra prediction described in relation to FIG. 2 and may perform an inter-view prediction based on encoding/decoding related information of a first base layer image (an image corresponding to a view different from that of the second base layer image).

Further, the decoder may decode a second enhancement layer image corresponding to a second view image. In this case, the decoder may perform an inter prediction and/or an intra prediction described in relation to FIG. 2 and may perform an inter layer texture prediction, an inter layer motion information prediction and/or an inter layer residual signal prediction based on encoding/decoding related information of a lower layer. The decoder may perform an inter-view prediction based on encoding/decoding related information of a first enhancement layer image (an image corresponding to a view different from that of the second enhancement layer image).

The decoder may decode other view images, not a first view image and a second view image with a method similar to that in a second view image. In this case, the decoder may decode a first view image to the Nth view image (here, n represents the number of maximum views necessary for generating 3D image) according to the number of maximum views necessary for generating a 3D image.

In the foregoing exemplary embodiments, in order to remove overlapping between views, an image of views different from a view to which an encoding/decoding target image belongs may be used for an inter-view prediction. In this case, in the foregoing exemplary embodiments, an image belonging to the same layer as a layer to which an encoding/decoding target image belongs may be used for encoding/decoding. However, the present invention is not limited thereto, the encoder/decoder may use an image belonging to a layer different from a layer to which an encoding/decoding target image belongs for an inter-view prediction.

In the foregoing exemplary embodiments, methods are described based on a flowchart with a series of steps or blocks, but the present invention is not limited to order of steps, and some step may occur with steps and orders different from the above-described step or may simultaneously occur. Further, it will be understood by those skilled in the art that steps illustrated in a flowchart are not limited and other steps are included or one or more step of a flowchart may be deleted without influencing on a range of the present invention.

The foregoing exemplary embodiment includes various aspects of illustrations. Although all possible combinations for representing various aspects may not be described, a person of ordinary skill in the art may recognize that another combination is possible. Therefore, it will be understood by those skilled in the art that various changes in form and details may be made therein without departing from the spirit and scope of the invention as defined by the appended claims.

What is claimed is:

1. A method of decoding video, the method comprising:
decoding first bitstream corresponding to a base layer image based on first decoding information corresponding to an image belonging to a view different from a view to which the base layer image belongs; and
decoding second bitstream corresponding to an enhancement layer image based on second decoding information corresponding to the base layer image and third decoding information corresponding to an image belonging to a view different from a view to which the enhancement layer image belongs.

2. The method of claim 1, wherein the base layer image and the enhancement layer image have different spatial resolutions.

3. The method of claim 1, wherein the base layer image and the enhancement layer image have different quality resolutions.

4. The method of claim 1, wherein the first decoding information, the second decoding information, and the third decoding information comprises at least one of texture information, motion information, residual signal information, and decoded signal information.

5. The method of claim 1, further comprising:
receiving single bitstream multiplexed based on a first network absolute layer (NAL) unit corresponding to the first bitstream and a second NAL unit corresponding to the second bitstream; and
extracting the first bitstream and the second bitstream from the single bitstream.

6. The method of claim 5, wherein a first NAL unit header corresponding to the first NAL unit comprises at least one of a first spatial identifier, a first temporal identifier, a first quality identifier, and a first view identifier,
a second NAL unit header corresponding to the second NAL unit comprises at least one of a second spatial identifier, a second temporal identifier, a second quality identifier, and a second view identifier,
the first spatial identifier, the first temporal identifier, the first quality identifier, and the first view identifier indicate a spatial resolution, a temporal resolution, a quality resolution, and a view resolution, respectively, corresponding to the base layer image, and
the second spatial identifier, the second temporal identifier, the second quality identifier, and the second view identifier indicate a spatial resolution, a temporal resolution, a quality resolution, and a view resolution, respectively, corresponding to the enhancement layer image.

7. The method of claim 6, wherein the extracting of the first bitstream comprises extracting the first bitstream based on information included in the first NAL unit header and extracting the second bitstream based on information included in the second NAL unit header.

8. The method of claim 1, wherein the decoding of the first bitstream comprises performing an inter-view prediction of the base layer image based on the first decoding information.

9. The method of claim 1, wherein the decoding of the second bitstream comprises performing at least one of an inter layer texture prediction, an inter layer motion information prediction, and an inter layer residual signal prediction of the enhancement layer based on the second decoding information.

10. The method of claim 1, wherein the decoding of the second bitstream comprises performing an inter-view prediction of the enhancement layer image based on the third decoding information.

11. A method of encoding video, the method comprising:
generating first bitstream corresponding to a base layer image by encoding the base layer image based on first encoding information corresponding to an image belonging to a view different from a view to which the base layer image belongs; and
generating second bitstream corresponding to an enhancement layer image by encoding the enhancement layer image based on second encoding information corresponding to the base layer image and third encoding information corresponding to an image belonging to a view different from a view to which the enhancement layer image belongs.

12. The method of claim 11, wherein the base layer image and the enhancement layer image have different spatial resolutions.

13. The method of claim 11, wherein the base layer image and the enhancement layer image have different quality resolutions.

14. The method of claim 11, wherein the first encoding information, the second encoding information, and the third encoding information comprises at least one of texture information, motion information, residual signal information, and encoded signal information.

15. The method of claim 11, further comprising generating single bitstream by multiplexing based on the first bitstream and the second bitstream.

16. The method of claim 11, wherein the encoding of the base layer image comprises performing an inter-view prediction of the base layer image based on the first encoding information.

17. The method of claim 11, wherein the encoding of the enhancement layer image comprises performing at least one of an inter layer texture prediction, an inter layer motion information prediction, and an inter layer residual signal prediction of the enhancement layer image based on the second encoding information.

18. The method of claim 11, wherein the encoding of the enhancement layer image comprises performing an inter-view prediction of the enhancement layer image based on the third encoding information.
